(19) United States
(12) Patent Application Publication
(10) Pub. No.: US 2025/0096586 A1
(43) Pub. Date: Mar. 20, 2025

(54) ADAPTIVE TRACKING CLAMP FOR BATTERY CHARGING SYSTEM

(71) Applicant: Analog Devices International Unlimited Company, Limerick (IE)

(72) Inventors: Olivier Stéphane Simon Depuits, Le Rouret (FR); Bruno Zurlinden, Grasse (FR); Thierry Jean-Claude Robert Tellier, Grasse (FR); Anthony Gabriel Lucien Arzur, Cagnes-sur-Mer (FR); Cedric Francois Raphael Blanc, Villeneuve Loubet (FR)

(21) Appl. No.: 18/796,005

(22) Filed: Aug. 6, 2024

Related U.S. Application Data
(60) Provisional application No. 63/582,796, filed on Sep. 14, 2023.

(51) Int. Cl. H02J 7/00

(52) U.S. Cl. CPC H02J 7/00712; H02J 7/00304

(57) ABSTRACT

An adaptive tracking clamp acting as an extra regulation loop that limits excursions, such as at a transition from one regulation loop to another. The adaptive tracking clamp is dynamically positioned relative to the level of the regulation loop in control. In case of fast transient events, the loop that is initially in control will quickly raise the output demand but in a first time get limited by the adaptive tracking clamp level; in a second time the adaptive tracking clamp algorithm incrementally increases the output demand until handing off control to the other regulation loop.

### CLAIM OF PRIORITY

This application claims the benefit of priority of U.S. Provisional patent application Ser. No. 63/582,796 titled “ADAPTIVE TRACKING CLAMP” to Olivier Stéphane Simon Depuits et al., filed on Sep. 14, 2023, the entire contents of which being incorporated herein by reference.

### FIELD OF THE DISCLOSURE

This document pertains generally, but not by way of limitation, to battery charging systems.

### BACKGROUND

Battery chargers are important components in the electronics industry, designed to replenish the power in batteries that fuel a vast array of devices, from compact handheld devices to expansive automotive systems. These chargers range from simple units providing a steady DC power output to complex systems that dynamically adjust charging parameters based on real-time feedback from the battery. The core objective of a battery charger is to facilitate efficient and safe charging, thereby extending the battery's operational lifespan and optimizing its performance while safeguarding against potential hazards like overcharging.

Within these systems, power converters play an important role, particularly in battery charger systems where they are responsible for supplying power not only to the battery but also directly to the mobile device system when needed, for example. These converters transform electrical power from one form to another, adjusting output to meet specific voltage and current requirements of the battery and the device. This capability is essential in applications ranging from small consumer electronics to large-scale industrial machinery and renewable energy systems, where precise power management is desirable.

The evolution of battery chargers and power converters has been significantly influenced by the growing emphasis on energy efficiency and the need to cater to an expanding array of electronic devices with diverse power demands. Continuous advancements in this field aim to enhance the efficiency, reliability, and safety of these systems. This involves the integration of advanced, adaptive power management technologies that are capable of intelligently responding to varying load conditions and power requirements, thereby supporting the next generation of electronic devices and systems with greater sophistication and environmental consciousness.

### SUMMARY OF THE DISCLOSURE

This disclosure describes, among other things, an adaptive tracking clamp acting as an extra loop that limits excursions (e.g., current overshoot), such as at a transition from one loop to another. The adaptive tracking clamp is dynamically positioned relative to the level of the regulation loop in control. In case of fast transient events, the loop that is initially in control will quickly raise the output demand but in a first time get limited by the adaptive tracking clamp level; in a second time the adaptive tracking clamp algorithm will incrementally increase the output demand until handing off control to the other loop. Benefits include accuracy and speed. Accuracy is achieved because the fine regulation loop, e.g., an analog loop, still takes over control after some time. Speed is achieved because the adaptive clamp takes control in case of fast transient events.

In some aspects, this disclosure is directed to a battery charging system comprising: a power converter circuit coupled with a battery and a power source; a multi-channel regulation system coupled with the power converter circuit, the multi-channel regulation system configured for generating an output demand signal representing an output demand current to the power converter circuit; and an adaptive tracking clamp circuit coupled with the multi-channel regulation system, wherein the adaptive tracking clamp circuit is configured for generating a clamp level signal representing a limit of the output demand current to limit current overshoot, and wherein the clamp level signal is applied to the multi-channel regulation system.

In some aspects, this disclosure is directed to an adaptive tracking clamp circuit configured for coupling with a multi-channel regulation system of a battery charging system, the adaptive tracking clamp circuit comprising: a digital control circuit configured for generating a clamp level signal representing a limit of an output demand current to limit current overshoot, wherein the clamp level signal is applied to the multi-channel regulation system; and a tracking system coupled with the digital control circuit, the tracking system configured for tracking an output current of the power converter circuit.

In some aspects, this disclosure is directed to a method of charging a battery, the method comprising: generating, by a multi-channel regulation system, an output demand signal representing an output demand current that is applied to a power converter circuit coupled with the battery; and generating a clamp level signal representing a limit of the output demand current to limit current overshoot; and applying the clamp level signal to the multi-channel regulation system.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a simplified block diagram of an example of a battery charging system.

FIG. 2 is a simplified block diagram of an example of a battery charging system that may implement various techniques of this disclosure.

FIG. 3 is a block diagram depicting an example of the battery charging system of FIG. 2 in more detail.

FIG. 4 is an example of a state diagram of the finite state machine of FIG. 3.

FIG. 5 is a schematic diagram depicting an example of the multi-channel regulation system of the battery charging system of FIG. 2 in more detail.

FIG. 6 is a flow diagram of an example of a method of charging a battery.

### DETAILED DESCRIPTION

One approach to a battery charging system includes using a regulation system with multiple regulations channels or loops that control one output demand current. For example, a switching mode charger for lithium-ion batteries may include regulations loops on battery voltage, battery current, system voltage, die temperature, input current, and output current. The regulation loops control the switcher inductor current demand (current-mode regulation). There may be a first requirement for these loops to be accurate (implying analog control loops or digital control loops with large resolution and compensation for stability) and a second requirement for at least one of these loops to have high bandwidth and for at least another to have low bandwidth.

The present inventors have recognized a need to avoid demand excursion out of bounds, such as current overshoot, which may occur following fast transient events causing transitions from high bandwidth loop(s) to low bandwidth loop(s) while maintaining the required accuracy and stability requirements.

This disclosure describes, among other things, an adaptive tracking clamp acting as an extra loop that limits excursions (e.g., current overshoot), such as at a transition from one loop to another. The adaptive tracking clamp is dynamically positioned relative to the level of the regulation loop in control. In case of fast transient events, the loop that is initially in control will quickly raise the output demand but in a first time get limited by the adaptive tracking clamp level; in a second time the adaptive tracking clamp algorithm will incrementally increase the output demand until handing off control to the other loop. Benefits include accuracy and speed. Accuracy is achieved because the fine regulation loop, e.g., an analog loop, still takes over control after some time. Speed is achieved because the adaptive clamp takes control in case of fast transient events.

The adaptive tracking clamp may be used for other range limiting features. In charger switcher applications, this allows for a programmable maximum switcher operating current and soft-start current ramps, for example. The clamp level may be bounded by predicting a minimal level of output demand (current floor) while still avoiding exceeding the (current) limit. In charger applications, this helps maximize charge speed in case of frequent load transients. The up and down speed of the tracking may be programmed, which allows tailoring of transient behavior depending on a particular application or scenario. The system may be enabled/disabled by an application processor depending on the use case requirements. In charger applications, this may be used to prioritize input current limit vs system current availability depending on adapter type, mode of operation, etc.

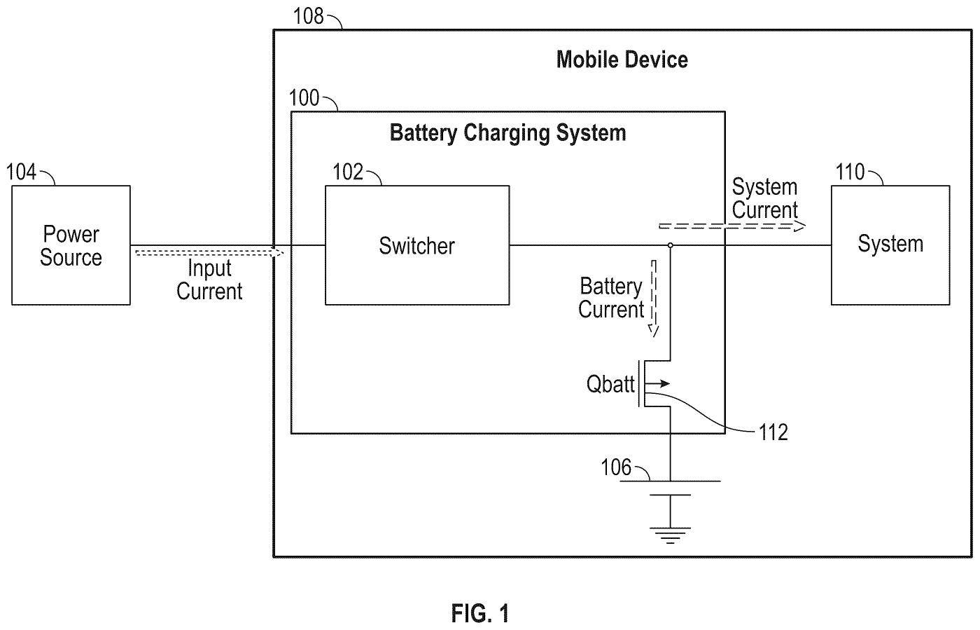

FIG. 1 is a simplified block diagram of an example of a battery charging system 100. The battery charging system 100 includes a switcher 102, such as a buck/boost power converter circuit, regulated switched-capacitor converter or hybrid switched-capacitor converter coupled with a power source 104. The power source 104 may be coupled with the battery charging system 100 using a Universal Serial Bus (USB) port, for example.

The switcher 102 uses a voltage from the power source 104 to charge the battery 106, such as a battery of a mobile device 108, via a transistor 112 (Qbatt) and also supplies a system voltage to a system 110, such as of the mobile device 108. In some examples, the battery 106 may be a lithium-ion battery. The switcher 102 may also be used in reverse as a boost converter so as to provide power to a USB port to supply an accessory or to a wireless charger. In some examples, the switcher 102 can directly connect to the battery 106.

When a valid adapter is present, the switcher 102 is on and provides current to the battery 106 and the system 110. The switcher 102 acts as a power converter, and obeys the following rules during charging: 1) charge the battery according to constant current (CC) or 2) constant voltage (CV) settings, 3) maintain system (SYS) voltage, 4) maintain input charging current (Ichgin) below a current limit (INLIM), and 5) maintain die temperature (Tdie). Each target is controlled through an individual regulation loop, with its own parameter(s), such as bandwidth, gain, and the like. Switching from one regulation loop to another is not an immediate action.

When the switcher 102 is regulating and there is a system current transient, the switcher 102 reacts for a certain amount of time according to the regulation loop in control. During constant current or constant voltage, the switcher 102 increases its input current as a response to the extra current needed. This happens until another regulation loop takes control. During this time, the input current is increased by an amount that depends on the output power needed. The present inventors have recognized that a problem to solve is that the input current may transitorily exceed the current limit setting. Once the input current regulation loop takes control, the input current is then regulated to the target current limit, even if the system current is maintained high and the battery 106 provides the extra current.

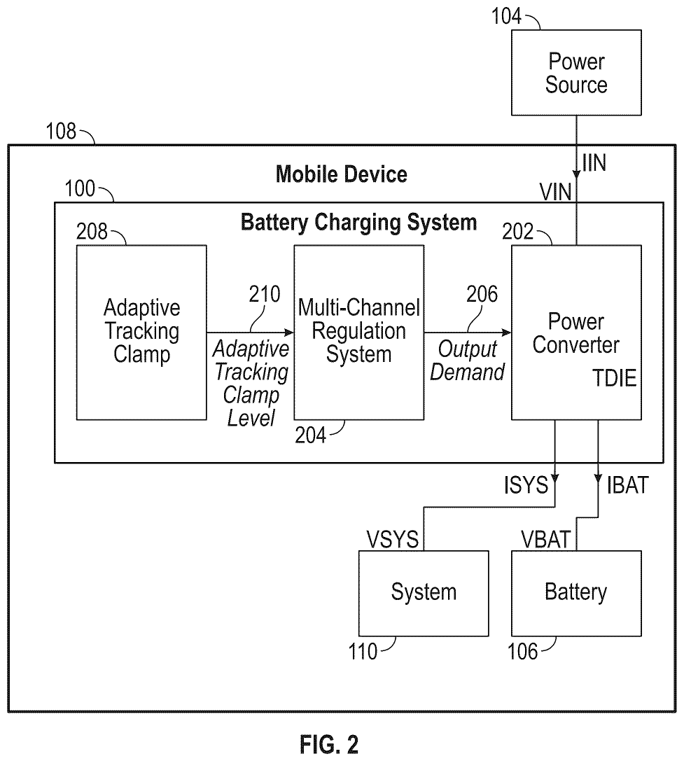

FIG. 2 is a simplified block diagram of an example of a battery charging system 100 that may implement various techniques of this disclosure. Like in FIG. 1, the battery charging system 100 is coupled with a battery 106 and a system 110, such as of a mobile device 108.

The battery charging system 100 includes a power converter circuit 202, which may be similar to the switcher 102 of FIG. 1, e.g., a buck/boost converter. The power converter circuit 202 is coupled with the battery 106 and the power source 104. The battery charging system 100 further includes a multi-channel regulation system 204. The multi-channel regulation system 204 is configured for generating an output demand signal 206, such as representing an output demand current, based on one or more sensed parameters, such as battery voltage, battery current, system voltage, die temperature, input current, and output current. The output demand signal 206 is applied to the power converter circuit 202.

The multi-channel regulation system 204 includes several regulation channels (also referred to as regulation loops), including channels for battery voltage, battery current, system voltage, die temperature, input current, and input voltage. The regulation channels control an inductor current demand (current-mode regulation) of the power converter circuit 202. One or more of the regulation channels have high bandwidth and one or more of the regulation channels have low bandwidth.

In accordance with this disclosure, the battery charging system 100 further includes an adaptive tracking clamp circuit 208 coupled with the multi-channel regulation system 204. The adaptive tracking clamp circuit 208 is configured for generating a clamp level signal 210 representing a limit of the output demand signal 206, such as an output demand current, that is applied to the multi-channel regulation system 204 so as to limit current overshoot. The adaptive tracking clamp circuit 208 of this disclosure acts as an extra regulation channel so as to limit or avoid demand excursion out of bounds (e.g., current overshoot) following fast transient events causing transitions from high bandwidth loop(s) to low bandwidth loop(s) while maintaining the accuracy and stability requirements. The adaptive tracking clamp circuit 208 dynamically positions its output relative to the level of the regulation channel in control by stepping up and down. In case of fast transient events, the adaptive tracking clamp circuit 208 will transitorily take control of the output demand and manage the transition from the loop initially in control to another loop without out-of-bound demand excursion.

The adaptive tracking clamp circuit 208 may be used for other range-limiting features. For example, in charger switcher applications, the adaptive tracking clamp circuit 208 allows for a programmable maximum switcher operating current, soft-start current ramps, and the like.

In some examples, the clamp level signal 210 is bounded on the low side by predicting a minimum level of output demand (e.g., current floor) while still avoiding exceeding the limit (e.g., current limit). In charger switcher applications, this helps maximize charge speed in case of frequent load transients.

In some examples, the up and down speed of the tracking is programmable by a user. This allows tailoring of transient behavior depending on the application or scenario.

The adaptive tracking clamp circuit 208 may be enabled/disabled by an application processor depending on the use case requirements. For example, in charger switcher applications, this may be used to prioritize input current limit versus system current availability depending on adapter type, mode of operation, etc.

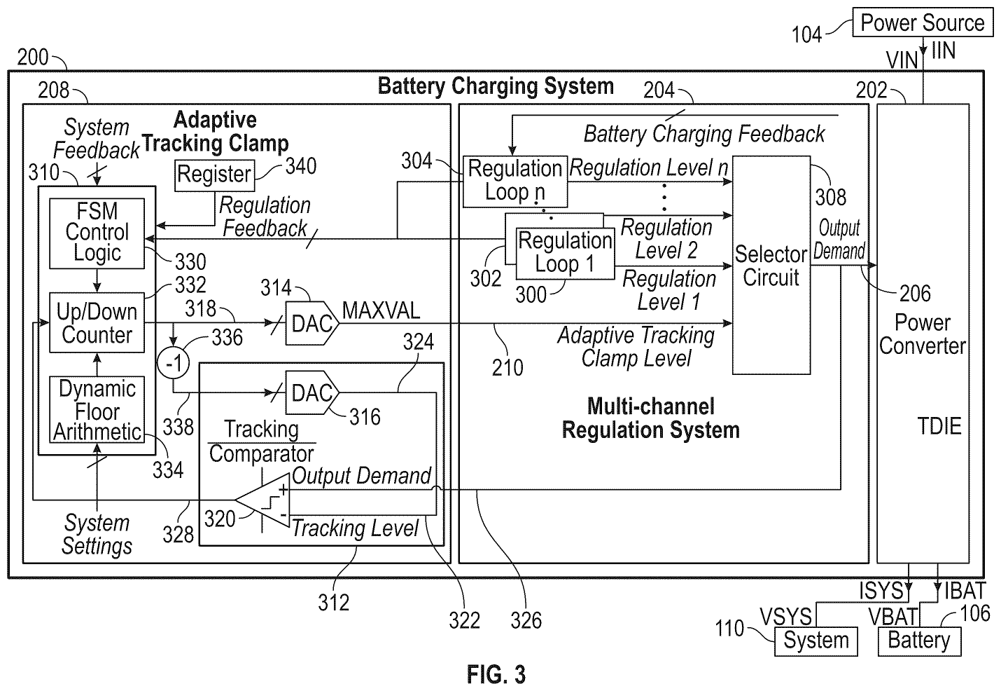

FIG. 3 is a block diagram depicting an example of the battery charging system 100 of FIG. 2 in more detail. The multi-channel regulation system 204 is configured for generating an output demand signal 206, such as representing an output demand current, that is applied to the power converter circuit 202. The output demand signal 206 is based on one or more sensed parameters, such as battery voltage, battery current, system voltage, die temperature, input current, and output current.

The multi-channel regulation system 204 includes several regulation channels (also referred to as “regulation loops”) for one or more sensed parameters of the mobile device, such as battery voltage, battery current, system voltage, die temperature, input current, and output current. The regulation channels control the inductor current demand of the power converter circuit 202 while it is in current-mode regulation. The multi-channel regulation system 204 includes a first regulation channel 300 (“regulation loop 1”), a second regulation channel 302, and so forth through an Nth regulation channel 304 (“regulation loop n”). In some examples, the multi-channel regulation system 204 includes only two regulation channels.

Each regulation channel is configured for generating a corresponding output that is applied to a selector circuit 308. For example, the first regulation channel 300 generates a first output signal (“regulation level 1”), the second regulation channel 302 generates a second output signal (“regulation level 2”), and so forth and the Nth regulation channel 304 generates an Nth output signal (“regulation level n”).

In a current mode control, the battery charging system 100 controls an inductor current of an inductor of the power converter circuit 202 using the regulation channels. These regulation channels attempt to regulate different sensed parameters of the system, such as the battery voltage. During charging of the battery 106, it may be desirable to regulate the battery current. So, depending on the type of battery and the customer application, the user may want to charge the battery faster or charge the battery slower, such as to avoid damaging the battery or extending the battery life. In the current mode control, an output signal of a corresponding regulation channel represents a target inductor current (peak, average or valley) with the minimum being the selected target of the power converter circuit 202. In some examples, four regulation channels may be used to regulate more than four variables of the mobile device, such as six or more variables.

The selector circuit 308 is configured for receiving the output signals of the regulation channels of the multi-channel regulation system 204. In addition, the selector circuit 308 is configured for receiving the clamp level signal 210 (“MAXVAL”) that is generated by the adaptive tracking clamp circuit 208 and applied to the multi-channel regulation system 204. The clamp level signal 210 represents the limit of the output demand current, shown as output demand signal 206, which is used to limit excursions such as current overshoot. The clamp level signal 210 allows for clamping the reaction of the power converter circuit 202. The clamp level signal 210 acts as another regulation channel. The selector circuit 308 selects a minimum value from amongst the received regulation channel output signals and the clamp level signal 210, where the minimum value represents the minimum current requirement for the power converter circuit 202. The clamp level signal 210 represents an absolute maximum for the minimum value selected by the selector circuit 308.

In some examples, the adaptive tracking clamp circuit 208 is configured for limiting current overshoot during a transition between a first regulation channel 300 and a second regulation channel 302 of the multi-channel regulation system 204.

The adaptive tracking clamp circuit 208 includes a digital control circuit 310 configured for generating the clamp level signal 210 and a tracking system 312 coupled with the digital control circuit 310. The tracking system is configured for tracking an output demand current of the power converter circuit, such as represented by the output demand signal 206. The adaptive tracking clamp circuit 208 attempts to limit excursions, such as by generating clamp level signal 210 above the actual output current. The actual output current will change over time, so the tracking system 312 tracks it up and down.

The adaptive tracking clamp circuit 208 also includes a clamp digital-to-analog converter 314 coupled with an output of the digital control circuit 310 and configured for generating the clamp level signal 210. The clamp digital-to-analog converter 314 generates, from a digital code 318 generated by the digital control circuit 310, the clamp level signal 210 that is applied to the multi-channel regulation system 204 and, in particular, to the selector circuit 308.

The tracking system 312 includes a tracking digital-to-analog converter 316 configured for receiving a digital code 338, which in some examples is the digital code 318 from the digital control circuit 310 plus an offset generated by an offset circuit 336. The tracking system 312 also includes an amplifier circuit 320 for comparing an output 324 of the tracking digital-to-analog converter 316 with the output demand signal 206, e.g., the actual buck current level, which is used to adjust the digital code 318 to achieve the tracking.

The amplifier circuit 320 includes a first input 322, e.g., an inverting input, coupled with the output 324 (“tracking level”) of the tracking digital-to-analog converter 316 and a second input 326, e.g., a non-inverting input, configured for receiving a representation of the current generated by the power converter circuit 202, namely the output demand signal 206. An output signal 328 of the amplifier circuit 320 is applied to the digital control circuit 310, and the digital control circuit 310 is configured for adjusting the digital code 318 based on the output signal 328 of the amplifier circuit 320. In some examples, the amplifier circuit 320 is in an open loop configuration.

The digital control circuit 310 is configured for generating the digital code 318, which represents the clamp level signal 210 and is based on the minimum level of the output demand current. In some examples, the digital control circuit 310 is configured for generating the minimum level of the output demand current that will limit the operating range while still guaranteeing not exceeding the target input current, based on one or more parameters affecting the input-to-output conversion of the power converter circuit. The parameters may include a programmable input current limit, a peak or valley operating mode, a programmable inductor value, and/or a programmable switching frequency. The digital control circuit 310 receives various inputs from the system and takes different actions so as to control the value of the clamp level signal 210. By using these inputs, the adaptive tracking clamp circuit 208 may maximize the available current to service the system 110, may maximize the charge current, and may reduce the charge time.

The digital control circuit 310 includes a finite state machine 330 that has a tracking state and a control state. The finite state machine 330 receives various system feedback parameters, such as a state of the power converter circuit 202, e.g., buck or boost, a regulation channel control status, and/or input current undershoot, and determines whether to increase or decrease the clamp level signal 210 and how quickly or slowly to increase or decrease so as to dynamically adjust to the conditions. The finite state machine 330 uses the system feedback parameters, like which regulation channel is in control, and starts adjusting the clamp level. If the regulation channel is not in control, the finite state machine 330 moves from the control state back to the tracking state.

The digital control circuit 310 also includes an up/down counter circuit 332 and a dynamic floor arithmetic circuit 334. The dynamic floor arithmetic circuit 334 helps the battery charging system 100 deliver as much current as possible and as soon as possible while not exceeding the input current limit. The dynamic floor arithmetic circuit 334 also helps avoid a system voltage collapse at startup and improves settling times by limiting the ramp-up time of the clamp level signal 210 (“MAXVAL”).

In some examples, the dynamic floor arithmetic circuit 334 may set the clamp level signal 210 floor just below the expected buck current at full load under input current limit control. The dynamic floor arithmetic circuit 334 may update the floor level based on various inputs, such as a programmable input current limit, a peak or valley operating mode, a programmable inductor value, and/or a programmable switching frequency. In this manner, the dynamic floor arithmetic circuit 334 provides a predictive dynamic floor.

The up/down counter circuit 332 receives an output of the dynamic floor arithmetic circuit 334, an output of the finite state machine 330, and the output signal 328 of the amplifier circuit 320 and, in response, generates the digital code 318. The digital code 318 is applied to the clamp digital-to-analog converter 314 and, via the offset circuit 336, to the tracking digital-to-analog converter 316.

If the demand of one of the regulation channels is lower than the clamp level signal 210 (“MAXVAL”), which indicates that that particular channel is in control, then the clamp level signal 210 is set to track the minimum if the minimum is more than a floor value, otherwise, the clamp level signal 210 is set to that floor value. The clamp level signal 210 tracks the minimum value plus a headroom value in steady state. The clamp level signal 210 clamps the minimum value during fast transient increase events, then increases gradually until the appropriate regulation channel takes back control.

In some examples, the speed of the adaptive tracking clamp circuit is programmable by a user. For example, the adaptive tracking clamp circuit 208 includes a register 340 coupled with the digital control circuit 310. The register 340 stores the speed information programmed by the user. In some examples, the register 340 is programmed using a serial communication protocol, such as Inter-Integrated Circuit (I2C).

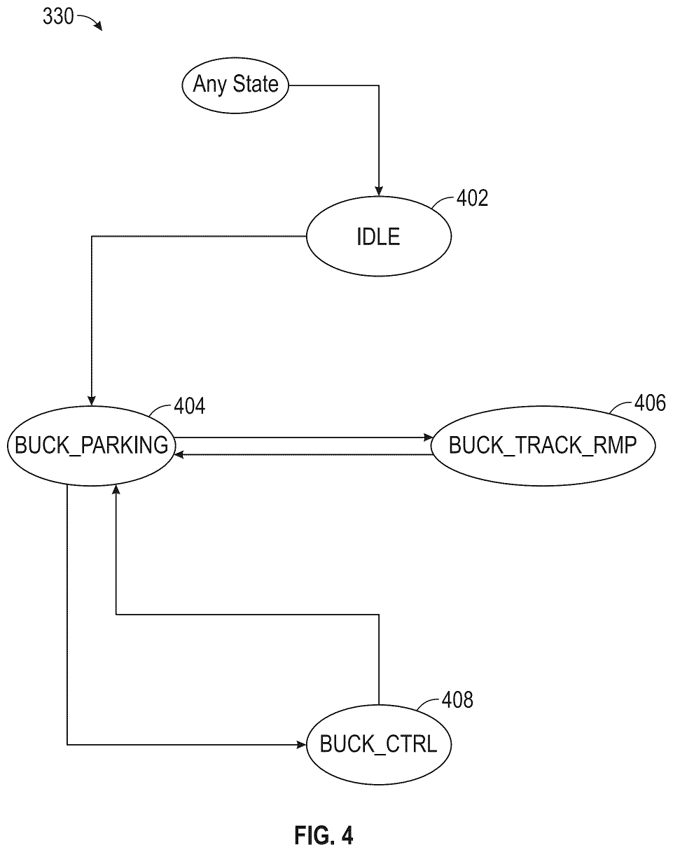

FIG. 4 is an example of a state diagram of the finite state machine 330 of FIG. 3. The finite state machine 330 includes four states: an idle state 402, a buck parking state 404, a buck tracking state 406, and a buck control state 408. In the idle state 402, the clamp level signal 210 (“MAXVAL”) is not under the control of the finite state machine 330.

The finite state machine 330 may move from the idle state 402 to the buck parking state 404. In the buck parking state 404, which is a tracking state, the adaptive tracking clamp circuit 208 is not actively controlling the output demand but is attempting to closely track the current. In this state, the clamp level signal 210 (“MAXVAL”) is under the control of the finite state machine 330. The response of the adaptive tracking clamp circuit 208 is designed to be highly responsive, decreasing rapidly to align with any reductions in the output current level, such as with a time base short enough to track up to the fastest regulation loop. Conversely, increases in current are managed more slowly, such as with a time base long enough for the slowest regulation loop to settle. This prevents the system from reacting to sudden spikes in current, opting instead to clamp down to manage such increases effectively.

The finite state machine 330 may move from the buck parking state 404 to the buck control state 408, during which time the clamp level signal 210 (“MAXVAL”) is in control. In the buck control state 408, the adaptive tracking clamp circuit 208 takes an active control role and the clamp level signal 210 (“MAXVAL”) is not under the control of the finite state machine 330. This ensures that the current level does not decrease but is allowed to increase incrementally, with a time base long enough for the slowest regulation loop to settle. The buck control state 408 persists until another regulation channel within the system signals a need to reduce the current, at which point control is handed off to that regulation channel. The finite state machine 330 may move from the buck control state 408 back to the buck parking state 404, during which time the clamp level signal 210 (“MAXVAL”) is not in control.

From the buck parking state 404, the finite state machine 330 may also move to the buck tracking state 406. The buck tracking state 406 may be used to smooth transitions when adjustments to current settings are needed. For instance, if a user sets a higher current level on the adapter input, the system avoids abrupt changes by smoothly ramping up to this new setting for the clamp level signal 210 (“MAXVAL”). This gradual approach prevents system disturbances and avoids false detections of load step events, which may occur if the system misinterprets a normal increase in input current as an anomaly. In the buck tracking state 406, the adaptive tracking clamp circuit 208 may adjust upwards rapidly, such as at a rate of one step every multiple of the fastest regulation loop time base, until it approaches the set limit. As it nears this limit, the system transitions back to the buck parking state 404 to decelerate the ramping process for the clamp level signal 210 (“MAXVAL”), allowing for careful management of any potential overshoots or system load steps.

By using these techniques, the ramp speed clamp level signal 210 (“MAXVAL”) is adaptable. The ramp speed may be asymmetric in that the ramp-up speed may be different than the ramp-down speed. In addition, the clamp level signal 210 (“MAXVAL”) may be adaptive based on various conditions, including whether the clamp level signal 210 or the regulation loops are in control, and based on control history, e.g., which regulation loop recently took control.

In some examples, the ramp-down speed of the clamp level signal 210 (“MAXVAL”) is a fast ramp, such as by tracking the fast regulation channel for a given time after the regulation loop takes control. In other examples, the ramp-down speed is a slow ramp to avoid mode transition oscillations.

In some examples, the ramp-up speed of the clamp level signal 210 (“MAXVAL”) depends on the regulation channel under control and the distance from the target value. When a regulation loop is in control, the adaptive tracking clamp circuit 208 uses a “target proximity detector” to select between the fast or slow ramp-up speed. When further away from the target value, the adaptive tracking clamp circuit 208 selects the fast ramp-up speed, which maximizes the available current. When approaching the target value, the adaptive tracking clamp circuit 208 selects the slow ramp-up speed, which helps to minimize the overshoot risk. When the clamp level signal 210 (“MAXVAL”) is in control, the adaptive tracking clamp circuit 208 selects the slow ramp-up speed, which helps limit overshoot.

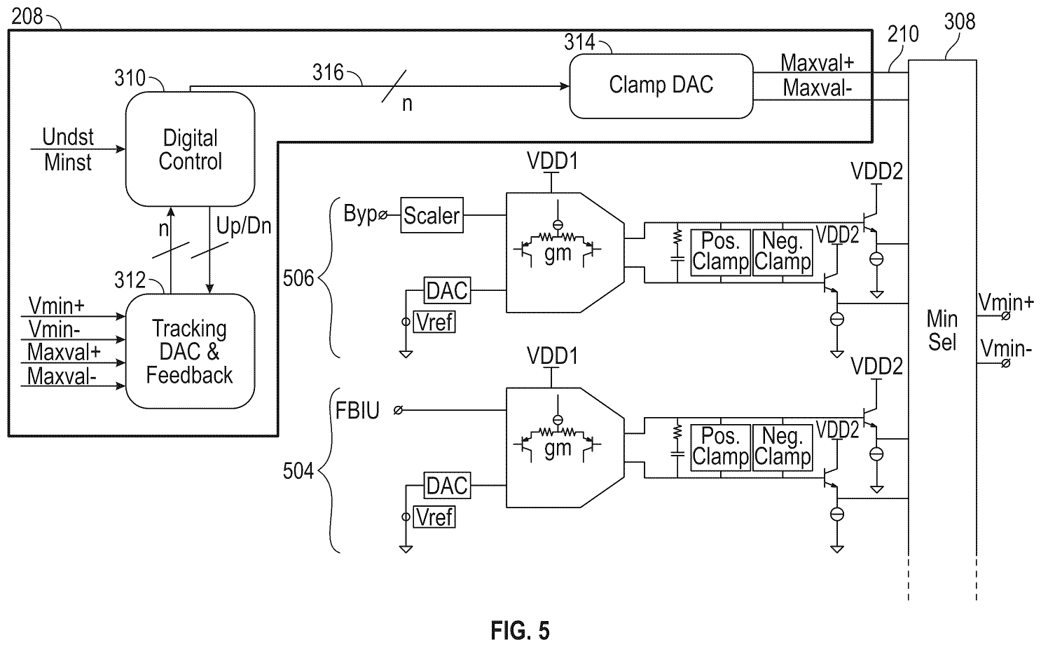

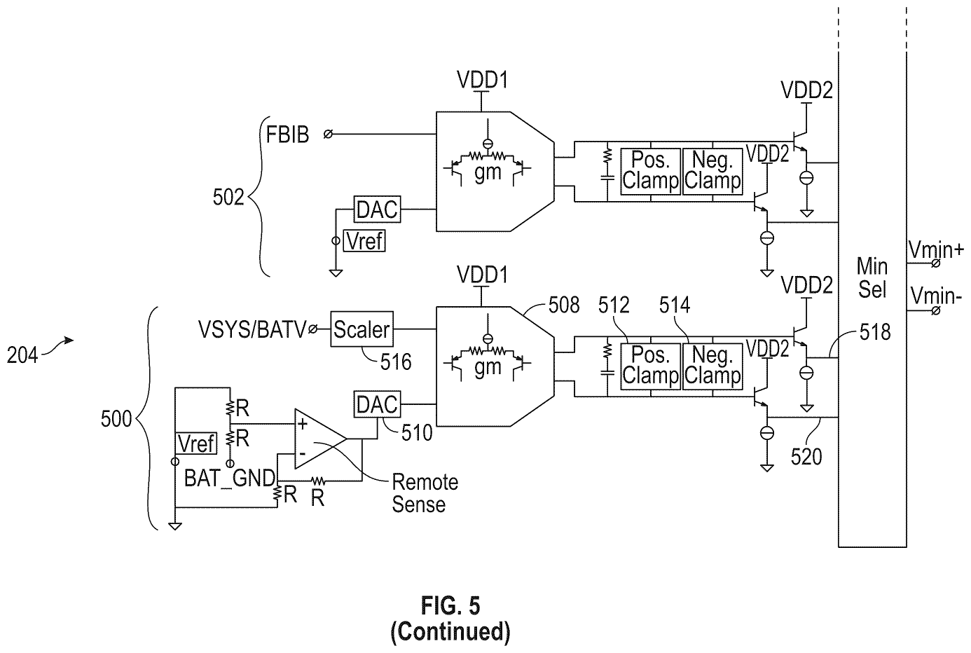

FIG. 5 is a schematic diagram depicting an example of the multi-channel regulation system 204 of the battery charging system 100 of FIG. 2 in more detail. As seen in FIG. 5, the digital control circuit 310 of the adaptive tracking clamp circuit 208 generates the n-bit digital code 318, which is applied to the clamp digital-to-analog converter 314 and converted to the clamp level signal 210 (“MAXVAL”). In response, the clamp digital-to-analog converter 314 generates a differential analog signal, shown as MAXVAL+ and MAXVAL−, which are both applied to the selector circuit 308. In addition, the differential analog signal, MAXVAL+ and MAXVAL−, are fed back to the tracking system 312 of the adaptive tracking clamp circuit 208.

The multi-channel regulation system 204 shown in FIG. 5 includes four regulation channels, namely a first regulation channel 500, a second regulation channel 502, a third regulation channel 504, and a fourth regulation channel 506. Each regulation channel includes an integrator, such as the integrator 508 of the first regulation channel 500. Each regulation channel includes a digital-to-analog converter, such as the digital-to-analog converter 510 of the first regulation channel 500, to program the target voltage or current.

Each regulation channel includes a positive clamp, such as the positive clamp 512 of the first regulation channel 500, which is used by the regulation channels that are not in control. Each regulation channel includes a negative clamp, such as the negative clamp 514 of the first regulation channel 500, which is used by the regulation channels to avoid reverse operation.

Each regulation channel is configured for receiving either voltage feedback or current feedback. For voltage regulation channels, such as the first regulation channel 500, the regulation channel includes a voltage scaler 516. For current regulation channels, a current sense amplifier may be used.

In addition, the regulation channels may include an error amplification stage. For voltage regulation channels, a transconductance stage (open loop) may be included. For current regulation channels, an amplifier stage (closed loop) may be included.

Each regulation channel generates a positive voltage signal and a negative voltage signal that are applied to the selector circuit 308. For example, the first regulation channel 500 generates a positive voltage signal at node 518 and a negative voltage signal at node 520. The selector circuit 308 then selects a minimum value between the signals provided by the regulation channels and the clamp level signal 210.

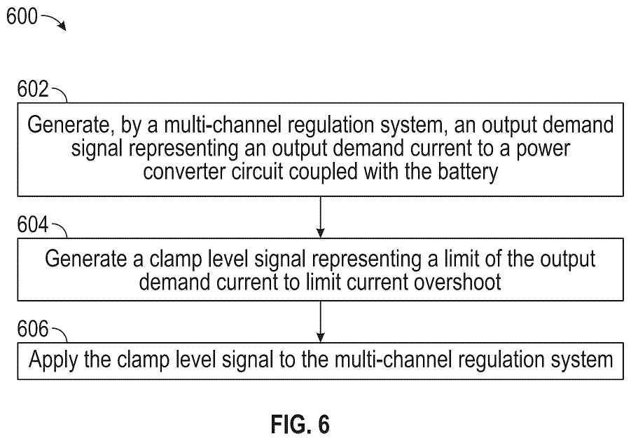

FIG. 6 is a flow diagram of an example of a method of charging a battery. At block 602, the method 600 generates, by a multi-channel regulation system, an output demand signal representing an output demand current that is applied to a power converter circuit coupled with the battery. For example, the multi-channel regulation system 204 generates an output demand signal 206 that is applied to the power converter circuit 202.

At block 604, the method 600 generates a clamp level signal representing a limit of the output demand current to limit current overshoot. For example, the adaptive tracking clamp circuit 208 generates a clamp level signal 210 representing a limit on the output demand signal 206 of FIG. 2.

At block 606, the method 600 applies the clamp level signal to the multi-channel regulation system. For example, the adaptive tracking clamp circuit 208 of FIG. 2 applies the clamp level signal 210 to the multi-channel regulation system 204.

In some examples, the method 600 includes receiving the clamp level signal and signals corresponding to channels of the multi-channel regulation system and selecting a minimum value, such as by the selector circuit 308.

In some examples, the method 600 includes receiving a digital code, receiving a representation of a current generated by a power converter circuit, and adjusting the digital code based on an output of an amplifier circuit, such as by using the tracking system 312 and the digital control circuit 310.

The method 600 may include additional actions related to the functionality described above.

### Various Notes

Each of the non-limiting claims or examples described herein may stand on its own, or may be combined in various permutations or combinations with one or more of the other examples.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more claims thereof), either with respect to a particular example (or one or more claims thereof), or with respect to other examples (or one or more claims thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAMs), read only memories (ROMs), and the like.

The above description is intended to be illustrative, and not restrictive. For example, the above-described examples (or one or more claims thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

1. A battery charging system comprising:
a power converter circuit coupled with a battery and a power source;
a multi-channel regulation system coupled with the power converter circuit, the multi-channel regulation system configured for generating an output demand signal representing an output demand current to the power converter circuit; and
an adaptive tracking clamp circuit coupled with the multi-channel regulation system, wherein the adaptive tracking clamp circuit is configured for generating a clamp level signal representing a limit of the output demand current to limit current overshoot, and wherein the clamp level signal is applied to the multi-channel regulation system.

2. The battery charging system of claim 1, wherein the adaptive tracking clamp circuit configured for generating the clamp level signal is configured for limiting current overshoot during a transition between a first regulation channel and a second regulation channel of the multi-channel regulation system.

3. The battery charging system of claim 1, wherein the multi-channel regulation system is configured for generating the output demand signal based on one or more sensed parameters.

4. The battery charging system of claim 1, wherein the adaptive tracking clamp circuit includes:
a digital control circuit configured for generating the clamp level signal; and
a tracking system coupled with the digital control circuit, the tracking system configured for tracking an output current of the power converter circuit.

5. The battery charging system of claim 4, comprising:
a clamp digital-to-analog converter coupled with an output of the digital control circuit and configured for generating the clamp level signal; and
a selector circuit configured for receiving the clamp level signal and signals corresponding to channels of the multi-channel regulation system and selecting a minimum value.

6. The battery charging system of claim 5, wherein the tracking system includes:
a tracking digital-to-analog converter configured for receiving a digital code;
an amplifier circuit having a first input coupled with an output of the tracking digital-to-analog converter and a second input configured for receiving a representation of a current generated by the power converter circuit, wherein an output of the amplifier circuit is coupled with the digital control circuit, and wherein the digital control circuit is configured for adjusting the digital code based on the output of the amplifier circuit.

7. The battery charging system of claim 6, wherein the amplifier circuit is in an open loop configuration.

8. The battery charging system of claim 4, wherein the digital control circuit is configured for generating a minimum level of the output demand current, and wherein the digital control circuit is configured for generating the digital code representing the clamp level signal based on the minimum level of the output demand current.

9. The battery charging system of claim 8, wherein the digital control circuit is configured for generating the minimum level of the output demand current based on one or more parameters affecting the input-to-output conversion of the power converter circuit.

10. The battery charging system of claim 9, wherein the one or more parameters are selected from the group consisting of: a programmable input current limit, a peak or valley operating mode, a programmable inductor value, and a programmable switching frequency.

11. The battery charging system of claim 4, wherein the digital control circuit includes a finite state machine including a tracking state and a control state.

12. The battery charging system of claim 1, wherein a speed of the adaptive tracking clamp circuit is programmable by a user.

13. An adaptive tracking clamp circuit configured for coupling with a multi-channel regulation system of a battery charging system, the adaptive tracking clamp circuit comprising:
a digital control circuit configured for generating a clamp level signal representing a limit of an output demand current to limit current overshoot, wherein the clamp level signal is applied to the multi-channel regulation system; and
a tracking system coupled with the digital control circuit, the tracking system configured for tracking an output current of the power converter circuit.

14. The adaptive tracking clamp circuit of claim 13, comprising:
a clamp digital-to-analog converter coupled with an output of the digital control circuit and configured for generating the clamp level signal.

15. The adaptive tracking clamp circuit of claim 13, wherein the digital control circuit includes a finite state machine including a tracking state and a control state.

16. The adaptive tracking clamp circuit of claim 13, wherein the tracking system includes:
a tracking digital-to-analog converter configured for receiving a digital code;
an amplifier circuit having a first input coupled with an output of the tracking digital-to-analog converter and a second input configured for receiving a representation of a current generated by the power converter circuit, wherein an output of the amplifier circuit is coupled with the digital control circuit, and wherein the digital control circuit is configured for adjusting the digital code based on the output of the amplifier circuit.

17. The adaptive tracking clamp circuit of claim 16, wherein the digital control circuit is configured for generating a minimum level of the output demand current, and wherein the digital control circuit is configured for generating the digital code representing the clamp level signal based on the minimum level of the output demand current.

18. A method of charging a battery, the method comprising:
generating, by a multi-channel regulation system, an output demand signal representing an output demand current that is applied to a power converter circuit coupled with the battery; and
generating a clamp level signal representing a limit of the output demand current to limit current overshoot; and
applying the clamp level signal to the multi-channel regulation system.

19. The method of claim 18, comprising:
receiving the clamp level signal and signals corresponding to channels of the multi-channel regulation system and selecting a minimum value.

20. The method of claim 18, comprising:
receiving a digital code;
receiving a representation of a current generated by a power converter circuit; and
adjusting the digital code based on an output of an amplifier circuit.
